(19) United States
(12) Patent Application Publication
(10) Pub. No.: US 2014/0013609 A1
(43) Pub. Date: Jan. 16, 2014

(54) BOTTLE DRYING RACK

(71) Applicants: Mike Kilgore, Green Bay, WI (US); Alan P. Paal, New Franken, WI (US); Andy Lee Kirkpatrick, Green Bay, WI (US); David A. Parrott, Mason, OH (US); Brandon Leedy, Mason, OH (US); Robert J. Godfrey, Baraboo, WI (US)

(72) Inventors: Mike Kilgore, Green Bay, WI (US); Alan P. Paal, New Franken, WI (US); Andy Lee Kirkpatrick, Green Bay, WI (US); David A. Parrott, Mason, OH (US); Brandon Leedy, Mason, OH (US); Robert J. Godfrey, Baraboo, WI (US)

(73) Assignee: NUK USA LLC, Hackensack, NJ (US)

(21) Appl. No.: 13/546,371

(22) Filed: Jul. 11, 2012

(51) Int. Cl. F26B 25/18; F26B 19/00

(52) U.S. Cl. 34/89; 34/237

(57) ABSTRACT

A drying rack assembly for drying and storing baby bottles and other component parts of baby bottles thereon including a base housing having an air duct inlet and a fan associated therewith, and at least one trunk module having at least one branch associated therewith, each trunk module having a passageway extending therethrough in communication with the air duct inlet and each branch having a passageway extending therethrough in communication with a trunk passageway. The fan is positioned in the vicinity of the air duct inlet for directing the flow of air through said at least one trunk module and through said at least one branch to assist in drying an item positioned on said branch. A plurality of trunk modules can be assembled in a modular configuration to increase the storage capacity of the overall assembly.

### BACKGROUND OF THE INVENTION

The present invention relates generally to a drying rack assembly and, more particularly, to an apparatus designed for drying and storing baby bottles and other component parts of baby bottles such as baby bottle nipples, collars and caps.

When handling and cleaning infant feeding equipment, the hygienic cleansing of baby bottles, baby bottle nipples and other component parts is of critical importance. Ideally, between each use, bottles and nipples should be thoroughly scrubbed and then sterilized for use. Proper cleaning and scrubbing after use is particularly important so as to get rid of and clear any remaining food or liquid particles such as fatty liquids, or liquids having suspended solids therein such as formula, cereal, or other infant feeding products. It is important to remove all such remaining food or liquid particles because these types of remaining particles and/or residue may serve as a breeding ground for bacteria, potentially causing illness or infection. Because baby bottles hold sustenance for infants, having clean and dry baby bottles are particularly important in order to minimize the risks of illness and/or infection.

A variety of items have been designed specifically for cleaning and drying baby bottles and these items are often found in households having young children as well as in a variety of caregiving facilities such as daycares and nurseries. Oftentimes, these items are one of many objects purchased to assist in maintaining a clean eating environment for babies. Because there are a wide variety of cleaning devices available to clean and sterilize containers/bottles which hold sustenance for infants, once these containers/bottles have been washed, they are typically left out on a countertop or elsewhere to air dry. Furthermore, the areas where these containers/bottles are left to air dry are frequently cluttered with a multitude of items including, but not limited to, bottle brushes, nipple brushes, collars, caps, bibs, towels, drying racks, formula containers, sterilizing equipment, pacifiers and other similar items. Leaving such containers/bottles and their component parts sitting out to air dry not only causes excessive clutter, but it also unnecessarily exposes the damp surfaces to germs, debris and dust. Consequently, there is a need for an improved drying apparatus that is compact, easy to use and which provides for a more thorough and quicker drying action. There is also a need to maintain clean, convenient storage spaces for items that come into direct contact with an infant's mouth so as to provide a clean sanitary environment.

### SUMMARY OF THE INVENTION

The present invention is directed to a drying rack assembly and, more particularly, to an apparatus which is designed for drying and storing baby bottles and other component parts of baby bottles such as baby bottle nipples, collars and caps. The drying rack assembly may include a base housing for enclosing the mechanical and electrical components of the drying rack assembly. The base housing may further include at least one grate rack positioned on the top face of the base housing for storing the component parts of baby bottles thereon. A drip tray may be positioned directly beneath the grate rack for catching water which may drip from items stored on the drying rack assembly.

The base housing further serves to support at least one trunk module. Each trunk module includes at least one branch, each branch designed for storing an item such as a baby bottle after washing. In one embodiment, a trunk module may have a plurality of branches to provide increased storage space on the drying rack assembly. Furthermore, a plurality of trunk modules may be assembled in a modular arrangement, one on top of another, such that the branches are spaced in a configuration which allows for the storage of a multitude of baby bottles and similar items on the drying rack assembly. It is thus envisioned that trunk modules may be added or removed, as desired, to accommodate varying storage needs.

The drying rack assembly further includes a power source located within the base housing. The power source is electrically connected to a motor and provides power thereto. The motor is in mechanical communication with a fan which is positioned at the entry to an air duct, the air duct directing the linear flow of air produced by the fan through passageways or openings associated with both the trunk module and the branches. The air travels through the various passageways and exits an opening associated with the terminal end portion of each branch for drying the item positioned on the branch.

The drying rack assembly may further include a cap which may be secured to the top face of a trunk module to support the modular arrangement of trunk modules and to contain and direct the flow of air through the branches. The fan may be operably connected to a timing mechanism in order to facilitate the timed drying of items stored on the drying rack assembly. The fan may be further connected to an indicator to display when the fan is in operation.

Specific advantages and features of the present assembly will be apparent from the accompanying drawings and the description of several illustrative embodiments of the present invention.

### DESCRIPTION OF THE DRAWINGS

FIG. 1 is a top perspective view of one embodiment of a drying rack assembly constructed in accordance with the teachings of the present invention.

FIG. 2 is a bottom perspective view of the drying rack assembly of FIG. 1.

FIG. 3 is a side elevational view of the drying rack assembly of FIG. 1.

FIG. 4 is an exploded side elevational view of the drying rack assembly of FIG. 1.

FIG. 5 is a partial cut away internal view of the drying rack assembly of FIG. 1 showing the motor, fan and power source associated therewith.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

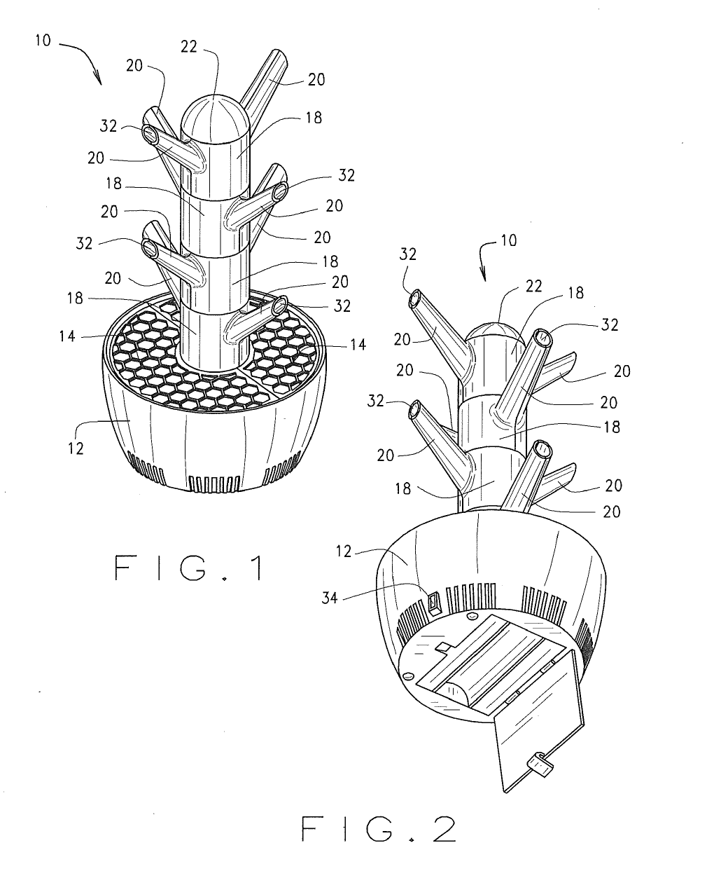

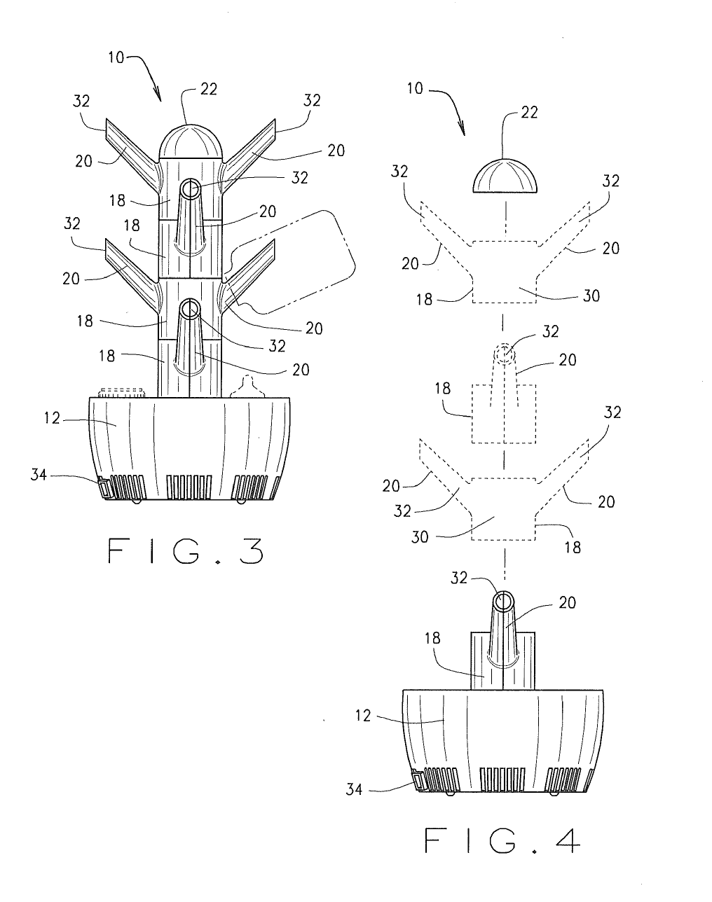

Referring now to the drawings more particularly by reference numbers, FIGS. 1-5 illustrate one embodiment of a drying rack assembly 10 which may be configured for drying and storing baby bottles and other component parts associated therewith such as baby bottle nipples, collars and caps thereon. The drying rack assembly 10 is designed for holding various types of infant feeding equipment in a hygienic, compact manner and in a way that assists in the drying thereof. As shown in FIG. 3, infant feeding equipment may include items such as baby bottles, baby bottle nipples, collars, caps, sippy cups, pacifiers and other similar items. In general, it should be understood that the present drying rack assembly 10 may be employed to hold and/or to facilitate the drying of a wide variety of articles other than baby bottles and their component parts without departing from the teachings and practice of the present invention.

In one embodiment, the drying rack assembly 10 includes a base housing 12 for enclosing the mechanical components of the drying rack assembly 10 as will be hereinafter further explained. The base housing 12 may further include at least one grate rack 14 positioned on the top face of the base housing 12 for storing the component parts of baby bottles thereon such as baby bottle caps, baby bottle nipples, collars and the like in order to facilitate the drying thereof The grate rack 14 may be removably or fixedly secured to the top face of the base housing 12. As illustrated in FIG. 5, a drip tray 16 may be positioned directly beneath the grate rack 14 for catching water which may drip from items stored on the drying rack assembly 10. It is preferred that the grate rack 14 be removably attachable to the base housing 12 so that any water captured by the dry tray 16 may be removed if necessary. Removal of the grate rack 14 will provide access to the drip tray 16 for removal of water therefrom.

The base housing 12 may further serve to support at least one trunk module 18. In this regard, the housing 12 includes an air duct inlet or collar 29 which is configured to mate with and engage one end portion of a trunk module 18 as will be hereinafter further explained. Each trunk module 18 includes at least one branch 20, each branch 20 being configured for supporting and/or storing an item thereon such as a baby bottle after washing. In one embodiment, a trunk module 18 may have a plurality of branches 20 to provide increased storage space on the drying rack assembly 10. Each trunk module 18 as well as the branches 20 are hollow and/or each include a passageway or opening extending at least partially therethrough in order to expedite drying of items stored on the respective branches 20 as will be hereinafter further explained. In this regard, each trunk module includes a main passageway or main air duct 30 extending therethrough and each branch 20 includes a passageway or opening 32 extending at least partially therethrough. One end portion of the trunk air duct 30 is sized and shaped to engage the air duct inlet or collar 29 as best shown in FIG. 5 such that the inlet 29 and air duct 30 are in communication with each other.

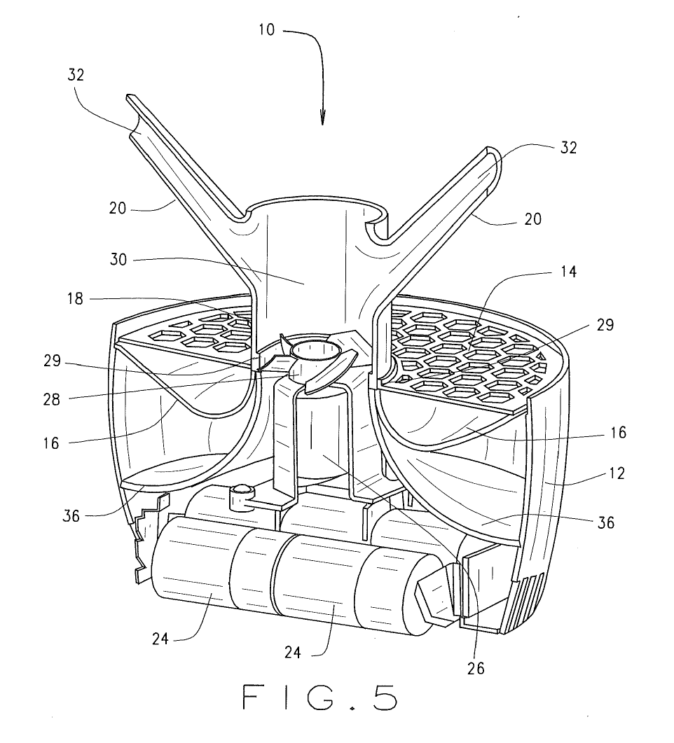

As illustrated in FIG. 4, a plurality of trunk modules 18 may be assembled in a modular arrangement such that the branches 20 are spaced in a configuration which allows for the storage of a multitude of items on the drying rack assembly 10. In this modular arrangement, the plurality of trunk modules 18 may be positioned such that the branches 20 extend outward in alternating directions, or in an angular offset arrangement, to allow for increased storage on the drying rack assembly 10. It is thus envisioned that trunk modules 18 may be added or removed, as desired, to accommodate varying storage needs. For example, a first trunk module 18 may be placed on top of a second trunk module 18 such that a branch 20 on the first trunk module 18 may be located circumferentially at an angle—preferably about 90°—with respect to a branch 20 located on the second trunk module 18. This angular offset arrangement provides the necessary space between branches vertically to ensure that items such as baby bottles can be easily positioned on each respective branch. It is further envisioned that in alternative embodiments, the trunk modules 18 may be split in half, or may take on other modular arrangements, for improved disassembly and storage when the drying rack assembly 10 is not in use. Trunk modules 18 may selectively connect to one another and/or to the air duct collar 29 of base housing 12 in various ways including, but not limited to, a threaded connection, a snap-in connection, a friction-based connection or any other suitable connection means including a wide variety of cooperatively engaging means. In this regard, one end portion of one module 18 will cooperatively engage with one end portion of an adjacent module 18 as illustrated in FIGS. 1-4 such that the respective trunk main air ducts 30 are in communication with each other. In still another embodiment, the plurality of trunk modules 18 may be affixed to each other via a unitary construction. The drying rack assembly 10 may further include a cap 22 which may be secured to the top end portion of the uppermost trunk module 18 to facilitate structural integrity and support to the modular arrangement of trunk modules 18, and for aesthetic reasons as well.

As illustrated in FIGS. 2 and 5, the drying rack assembly 10 also includes a power source 24 located within the base housing 12. It is envisioned that the power source 24 may include, but is not limited to, at least one battery, an AC power supply, a DC power supply, a detachable power supply, or any combination thereof. The power source 24 is electrically connected to a motor 26 for providing power thereto. The motor 26 is preferably in mechanical communication with a fan 28 such that the motor 26 drives the rotation of the fan 28. The fan 28 is positioned adjacent to or in the vicinity of the entry to air duct inlet 29 and any air ducts 30 in communication therewith. Each air duct 30 may be formed by the hollow portion or opening formed within each trunk module 18 such that as a trunk module 18 is engaged with the inlet or collar 29 of base housing 12, or with any other trunk modules 18 already engaged with the base housing 12, the respective air ducts 30 correspondingly extend up through each such respective trunk module 18. In similar fashion, each branch 20 is likewise either hollow or includes an opening or passageway 32 extending at least partially therethrough, each branch opening 32 being in communication with a main air duct 30. The respective air ducts 30 then direct the flow of air produced by the fan 28 up and through the respective branches 20, where the air then exits from the terminal end of each branch opening 32 for assisting in drying the item positioned on each such branch 20. In one embodiment, the trunk module 18 may be substantially cylindrical in shape and preferably sized to facilitate air flow to the respective branches 20. It is understood that each trunk module 18 may be fashioned into other shapes, as desired, to accommodate various alternative designs of the drying rack assembly 10 without departing from the teachings and practice of the present invention so long as the respective air ducts 30 communicate with all of the branch openings 32. It is also recognized that the terminal end portion of each branch may be closed and that a plurality of openings (not shown) may extend through the side walls forming each branch in communication with the opening 32 extending at least partially along the length of each branch such that air can exit through the side walls of each branch for assisting in the drying process. The cap 22 which is secured to the top end portion of the uppermost trunk module 18 also functions to keep the flow of air within the modular arrangement of trunk modules 18.

In one embodiment, the fan 28 may be operably connected to a timing mechanism (not shown) in order to facilitate the timed drying of items stored on the drying rack assembly 10. The timing mechanism may provide the user with a variety of options for timed drying, depending on the length of time desired. The fan may be further connected to an indicator 34 (FIG. 2), for example, an LED light, to display when the fan 28 is in operation. In one embodiment, the fan 28 may sit at the narrow end of an air funnel 36 (FIG. 5) for assisting in directing air flow to the trunk modules 18.

Thus, there has been shown and described several embodiments of a novel drying rack assembly. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A drying rack assembly comprising:
a base housing having an air duct inlet;
at least one trunk module having at least one branch, said trunk module being engageable with said air duct inlet and including a main passageway extending therethrough, said main passageway being in communication with said air duct inlet, said at least one branch including a passageway extending therethrough, said branch passageway being in communication with said main passageway;
a fan positioned in the vicinity of the air duct inlet for directing the flow of air produced by the fan through said air duct inlet and through said at least one trunk module and said at least one branch wherein the air exiting the opening of said at least one branch assists in drying an item positioned on said branch; and
a power source for operating said fan.

2. The drying rack assembly according to claim 1 wherein said base housing further includes a grate rack for storing items thereon.

3. The drying rack assembly according to claim 2 wherein said base housing further includes a drip tray positioned below said grate rack.

4. The drying rack assembly according to claim 1 including a plurality of trunk modules, each trunk module being cooperatively engageable with another trunk module.

5. The drying rack assembly according to claim 4 wherein each trunk module includes a plurality of branches.

6. The drying rack assembly according to claim 1 including a cap positionable on the top end portion of said at least one trunk module.

7. The drying rack assembly according to claim 1 wherein said base housing further includes an indicator for displaying when said fan is in operation.

8. A drying rack assembly comprising:
a plurality of trunk modules selectively engageable with each other to form a modular configuration, each trunk module having a main air duct associated therewith extending therethrough, the main air ducts of each respective trunk module connected together in a modular configuration lying in communication with each other;
a plurality of branches associated with each trunk module, each branch having an opening extending at least partially therethrough in communication with the main air duct associated with a respective trunk module, each branch being capable of holding a baby bottle thereon; and
a fan positioned to direct air through said plurality of trunk modules and through said openings associated with said branches to assist in drying items stored thereon, said fan being electrically coupled to a power source.

9. The drying rack assembly according to claim 8 including a base housing, said housing incorporating said fan and said power source.

10. The drying rack assembly according to claim 9 wherein said base housing includes an air duct inlet for receiving said plurality of trunk modules.

11. The drying rack assembly according to claim 10 wherein said plurality of trunk modules are unitary in construction.

12. The drying rack assembly according to claim 8 wherein said base housing further includes a grate rack for storing items thereon.

13. The drying rack assembly according to claim 12 wherein said base housing further includes a drip tray positioned below said grate rack.

14. The drying rack assembly according to claim 8 including a cap positionable on the top end portion of said at least one trunk module.

15. The drying rack assembly according to claim 8 wherein said base housing further includes an indicator for displaying when said fan is in operation.

16. The drying rack assembly according to claim 8 wherein the branches associated with one trunk module are angularly offset from the branches associated with another trunk module when said trunk modules are connected together in a modular configuration.
